(19) United States
(12) Patent Application Publication
(10) Pub. No.: US 2007/0110400 A1
(43) Pub. Date: May 17, 2007

(54) Apparatus for reproducing data and method thereof

(76) Inventors: Kun Suk Kim, Anyang-si (KR); Jea Yong Yoo, Seongam-si (KR)

Correspondence Address: HARNESS, DICKEY & PIERCE, P.L.C., P.O. BOX 8910, RESTON, VA, 20195, US

(21) Appl. No.: 11/599,365

(22) Filed: Nov. 15, 2006

Related U.S. Application Data
(60) Provisional application No. 60/737,409, filed on Nov. 17, 2005.

(30) Foreign Application Priority Data
Apr. 19, 2006 (KR) 10-2006-035235

(51) Int. Cl. H04N 7/00

(52) U.S. Cl. 386/95

(57) ABSTRACT

In one embodiment, the apparatus includes a decoder and a memory. The decoder is configured to decode a text subtitle reproduced from the recording medium. The memory is configured to store text subtitle capability information indicating whether the apparatus has at least one text subtitle capability.

### FOREIGN PRIORITY INFORMATION

This application claims the benefit of the Korean Patent Application No. 10-2006-035235, filed on Apr. 19, 2006, which is hereby incorporated by reference as if fully set forth herein.

### DOMESTIC PRIORITY INFORMATION

This application claims the benefit of the U.S. Provisional Application No. 60/737,409, filed Nov. 17, 2005, which is hereby incorporated by reference as if fully set forth herein.

### BACKGROUND OF THE INVENTION

1. Field of the Invention

The present invention relates to an apparatus for reproducing data stored in a recording medium or storage and method thereof, and more particularly, to an apparatus for reproducing a text subtitle stream stored in a recording medium or storage and method thereof. The present invention also relates to a method and apparatus for storing text subtitle management information. Although the present invention is suitable for a wide scope of applications, it is particularly suitable for various application fields, and more particularly, for reproducing a text subtitle stream data stored in a recording medium or storage efficiently.

2. Discussion of the Related Art

Recently, optical discs capable of recording large amounts of data as record media are being widely used. To meet the rising demand for video data of high image quality and audio data of high sound quality, HDTV and MPEG2 have been provided. For instance, if video data amounting to one HDTV movie is stored in a disc with MPEG2 image quality, a high-density recording medium having at least 20 Gbyte data storage capacity is demanded.

To meet this demand, Blu-ray disc, HD-DVD (high-definition digital video versatile disc) and the like have been developed as next generation recording media. And, many efforts have made to develop an optical record player according to high definition recording medium specifications.

However, in order to efficiently reproduce data recorded in a recording medium, various kinds of user-convenient data such as main AV data, subtitle information as supplementary data associated with the main AV data and the like need to be provided.

And, management information for reproducing main data and supplementary data recorded in an optical disc should be provided.

Moreover, a definition is needed to indicate whether a reproduction apparatus can support a reproduction of supplementary data, and more particularly, a reproduction of a subtitle stream file.

### SUMMARY OF THE INVENTION

The present invention relates to a reproducing apparatus for reproducing data from a recording medium.

In one embodiment, the apparatus includes a decoder and a memory. The decoder is configured to decode a text subtitle reproduced from the recording medium. The memory is configured to store text subtitle capability information indicating whether the apparatus has at least one text subtitle capability.

For example, the text subtitle capability information may include one or more of user changeable style capability information indicating whether the apparatus supports allowing a user to change style information for displaying a text subtitle; text flow information indicating text subtitle flow and alignment combinations supported by the apparatus; outline border capability information indicating whether a display of an outline border is supported by the apparatus; inline style capability information indicating whether the apparatus supports handling inline style information; and font type information indicating whether the apparatus supports at least one font type for display of text subtitles.

The text subtitle capability information may further include unsupported capability information indicating whether a text subtitle not supported by the apparatus is selectable by a user operation for reproduction from the recording medium.

In another embodiment, the apparatus includes a decoder, a memory and a control unit. The decoder is configured to decode a text subtitle reproduced from the recording medium. The memory is configured to store text subtitle capability information indicating whether the apparatus has at least one text subtitle capability. The control unit is configured to control operation of the apparatus based on the text subtitle capability information such that a text subtitle is reproduced from the recording medium if the text subtitle capability information indicates the apparatus is capable of reproducing the text subtitle.

The present invention also relates to a method for managing reproduction of data from a recording medium.

In one embodiment, the method includes storing text subtitle capability information in a reproducing apparatus, the text subtitle capability information indicating whether the apparatus has at least one text subtitle capability associated with reproducing text subtitles from the recording medium.

In another embodiment, the method further includes controlling operation of the apparatus based on the text subtitle capability information such that a text subtitle is reproduced from the recording medium if text subtitle capability information indicates the apparatus is capable of reproducing the text subtitle.

The present invention still further relates to a storage medium for managing reproduction of data from a recording medium.

In one embodiment, the storage medium includes a status register in a reproducing apparatus. The status register stores text subtitle capability information indicating whether the apparatus has at least one text subtitle capability associated with reproducing text subtitles from the recording medium.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a diagram of one embodiment of reproducing data within a recording medium and/or storage via an optical record player;

FIG. 2 is a diagram of a file structure recorded in an optical disc as a recording medium according to an embodiment of the present invention;

FIG. 3 is a diagram of a data storage area within an optical disc according to an embodiment of the present invention;

FIG. 4 is a diagram of a text subtitle and a main image displayed on a display screen according to an embodiment of the present invention;

FIG. 5 is a diagram of a structure for reproduction management of a text subtitle stream according to an embodiment of the present invention;

FIGS. 6A to 6C are exemplary diagrams for applications of reproduction control information for reproducing a text subtitle stream according to an embodiment of the present invention;

FIG. 7 is an exemplary diagram of syntax of a text subtitle stream file according to an embodiment of the present invention;

FIGS. 8A to 8E are detailed diagrams of a “dialog_style_segment( )” indicating a dialog style segment (DSS) according to an embodiment of the present invention;

FIGS. 9A to 9C are detailed diagrams of a “dialog_presentation_segment( )” indicating a dialog presentation segment (DPS) according to an embodiment of the present invention;

FIG. 10 is a schematic block diagram of an overall configuration of an optical record player according to an embodiment of the present invention;

FIG. 11 is a schematic block diagram of a playback system according to an embodiment of the present invention;

FIG. 12 is a diagram of a data reproducing apparatus utilizing a playback system according to an embodiment of the present invention;

FIG. 13A is an exemplary diagram of a status memory unit provided to a reproducing apparatus according to an embodiment of the present invention;

FIG. 13B is an exemplary diagram of PSR30 as a part of the status memory unit shown in FIG. 13A; and

FIG. 14 is a flowchart of a sequence of reproducing data according to an embodiment of the present invention.

### DETAILED DESCRIPTION OF EXAMPLE EMBODIMENTS

Reference will now be made in detail to the example embodiments of the present invention, which are illustrated in the accompanying drawings. Wherever possible, the same reference numbers will be used throughout the drawings to refer to the same or like parts.

First of all, a recording medium used in the present invention includes an optical disc such as DVD, Blu-ray disc (BD), HD-DVD, NFR (near field recording) disc, etc. For convenience of explanation, the present invention takes an optical disc, and more particularly, “Blu-ray disc (BD)” as an example of a record medium. Yet, it is apparent that the technical idea of the present invention is applicable to other record media and other types of optical disc—including HD-DVD and the like.

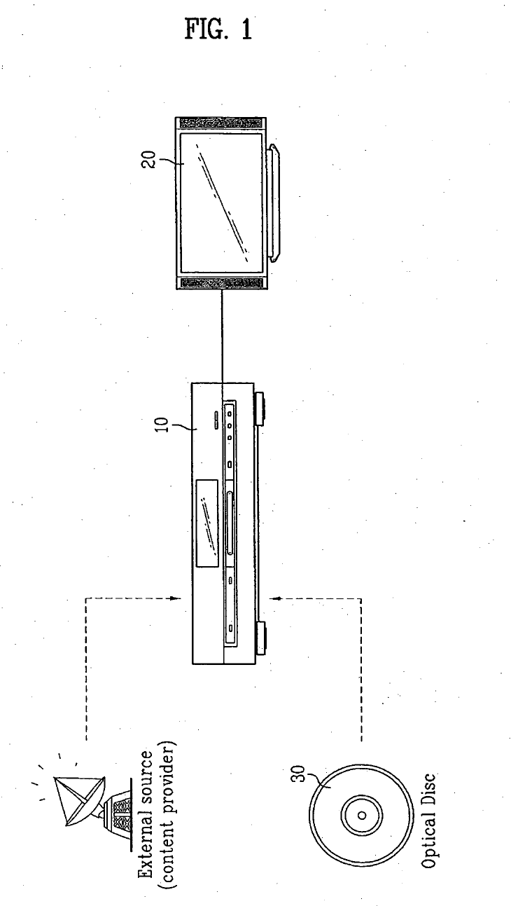

In the present invention, “Storage” may be a storage means provided within an optical record player shown in FIG. 1 and may be an element in which a user can randomly store information and data. In particular, the storage, which is currently used in general, includes “hard disc”, “system memory”, “flash memory” or the like, which does not put limitations on the scope of the present invention.

Specifically, the “Storage” is utilized as a means for storing data associated with a record medium. The data associated with the record medium to be stored within the storage generally includes data downloadable from outside.

Also, data directly read out of a record medium in part or generated system data (e.g., metadata, etc.) associated with reproduction of data recorded in the record medium may be stored within the storage.

Data recorded within the record medium shall be named “original data” and the data associated with the record medium among the data stored within the storage shall be named “additional data” existing outside a disc. The original and additional data are classified according to acquisition methods only. So, data existing outside an optical disc to have any kind of attribute associated with original data can be called additional data.

“Title” used in the following description is a reproduction unit configuring an interface with a user. Each title is linked to a specific object. And, a stream associated with the corresponding title recorded within a disc is reproduced according to a command or program within the object. In particular, for explanation convenience of the present invention, a title having moving pictures, movie and interactive information according to MPEG2 compression among titles recorded within a disc shall be named “HDMV Title”. And, a title having moving picture, movie and interactive information executed by a Java program among titles recorded within a disc shall be named “BD-J Title”.

“Main data” used in the following description means audio/video data belonging to a title (e.g., ‘movie title’) recorded within an optical disc by a disc author. In general, main data is recorded in MPEG2 format, and is called “AV stream” or “main AV stream”.

“Supplementary data” used in the following description means all kinds of data used in reproduction of the “main data”. For instance, supplementary data includes a text subtitle stream, an interactive graphic stream, a presentation graphic stream, a supplementary audio stream (e.g., applied for browsable slideshow) and the like. The supplementary data is recorded in MPEG2 or other format. And, the supplementary data is recorded by being multiplexed with a main AV stream or can exist as an independent data file within an optical disc.

“Subtitle” means caption information corresponding to a played video or image and is represented as a specific language. For instance, in case that a user selects one of a plurality of subtitles provided as various languages while viewing an image on a display screen, caption information corresponding to the selected subtitle is displayed on one side within the display screen. If the displayed caption information is constructed with character data, the selected subtitle shall be named “text subtitle”. In the present invention, “MPEG2 format” means that encoding and decoding are performed according to an internationally approved specification according to ISO/IEC-1318 standard. By the present invention, a plurality of subtitle streams are recordable within an optical disc according to MPEG2 format and there can exist as a plurality of independent stream files. And, each text subtitle stream file is generated and recorded within an optical disc.

The above-explained terminologies are replaceable by any terms indicating the same functions, respectively.

FIG. 1 shows one embodiment of reproducing data within a recording medium and/or storage via an optical record player.

Referring to FIG. 1, “Optical record player” 10 according to the present invention enables a record or playback of an optical disc according to versatile specifications. And, the optical record player 10 can be designed to record/play an optical disc (e.g., BD) of a specific specification. Moreover, the optical record player 10 can be made to play an optical disc only. In the following description of the present invention, by considering interactivity between a Blu-ray disc (BD) and a peripheral device, a BD-player playing back a Blu-ray disc (BD) or a BD-recorder recording/playing a Blu-ray disc (BD) will be taken as an example. And, it is apparent that the “optical record player” 10 may include or cover a “drive” loadable within a computer or the like.

The optical record player 10 according to the present invention is equipped with a function of recording/playing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of Internet as an easily accessible medium, specific data on the Internet can be downloaded via the optical record player 10 to be utilized.

The original data and the additional data will be explained in detail as follows. For instance, if a multiplexed AV stream for a specific title is recorded as an original data recorded within an optical disc and if an audio stream (e.g., English) different from the audio stream (e.g., Korean) of the original data is provided as an additional data over the Internet, a request for downloading the audio stream (e.g., English) as the additional data to reproduce together with the AV stream of the original data or a request for downloading the audio stream (e.g., English) as the additional data to reproduce only will exist according to a user. To enable the requests, association between the original data and the additional data is regulated, and a systematic method of managing/reproducing the data according to the user's request is provided.

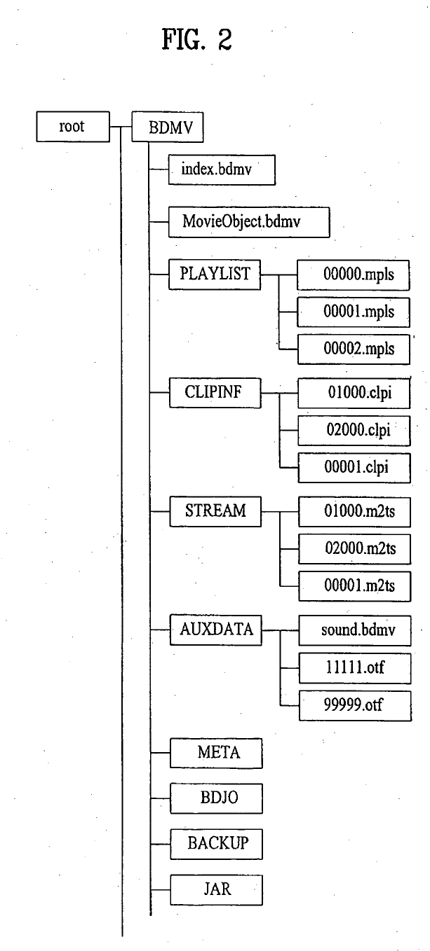

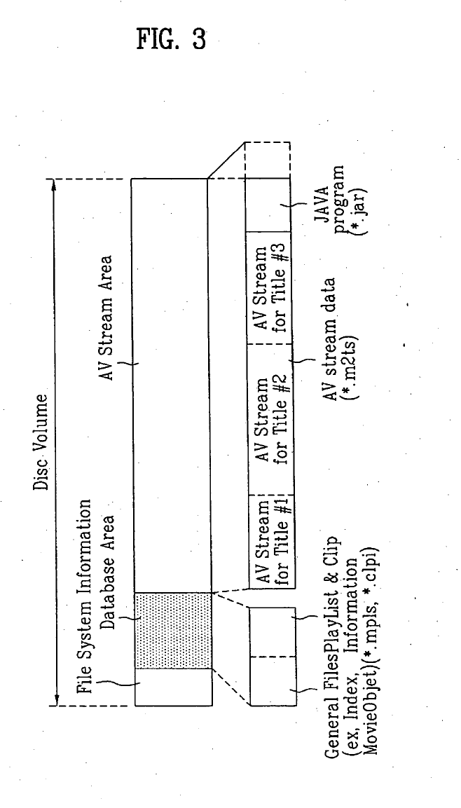

To realize the user's requests, a file structure between the original data and the additional data is provided. File and data record structures usable for a Blu-ray disc (BD) are explained in detail with reference to FIG. 2 and FIG. 3 as follows.

FIG. 2 is a diagram of a file structure recorded within an optical disc as a recording medium according to an embodiment of the present invention, in which a file structure for reproduction management of original data recorded within a disc is shown.

Referring to FIG. 2, at least one BDMV directory exists below one root directory. An index file (“index”) and an object file (“MovieObject”) as general file (higher file) information to secure interactivity with a user are included within the BDMV directory. For instance, the index file includes data indicating an index table. And, the index table has a plurality of selectable menus and movie titles. Moreover, each BD directory BDMV further includes four directories including AV data and various data for reproduction of the AV data.

Namely, file directories included in the BD directory BDMV are a stream directory “STREAM”, a clipinfo directory “CLIPINF”, a playlist directory “PLAYLIST” and an auxiliary data directory “AUXDATA”.

First of all, the stream directory “STREAM” includes audio and video (AV) stream files recorded within a disc by a specific format. For instance, since an AV stream is recorded as MPEG2 type transport packets, the stream file, as shown in FIG. 2, is named “*.m2ts”. The stream directory can include at least one or more text subtitle streams. Each of the text subtitle streams includes text data for a text subtitle represented as a specific language and reproduction management information for the text data. Moreover, the text subtitle stream file can exist as an independent file within the stream directory. The text subtitle stream file can be named “*.m2ts” or “*.txtst”. An AV stream file and a text subtitle stream existing within the stream directory can be named a ‘clip stream file’.

The clipinfo directory “CLIPINF” includes clip information files (“*.clpi”) having a one-to-one correspondence with the stream files (*.m2ts). In particular, each of the clip information files (“*.clpi”) includes attribute information and timing information of the corresponding stream file. For instance, a clipinfo file includes mapping information. And, the mapping information indicates information for one-to-one correspondence between a presentation time stamp (PTS) and a source packet number (SPN) by an entry point map (EPM). A specific position of a stream file (*.m2ts) is determined from timing information (IN-time, Out-Time) provided by PlayItem or SubPlayItem explained later using the mapping information. In the specification of standard, the pair of a stream file (*.m2ts) and associated clipinfo file (*.clpi) is called a ‘clip’. For instance, a file ‘0.1000.clpi’ within the clipinfo directory CLIPINF includes attribute information and timing information for a file ‘01000.m2ts’ within the stream directory file STREAM. Hence, the files ‘01000.clpi’ and ‘01000.m2ts’ form one clip.

Referring to FIG. 2 again, the playlist directory “PLAYLIST” includes at least one or more playlist files (*.mpls). And, each of the playlist files (*.mpls) includes at least one PlayItem designating a playing interval of a specific clip. In particular, a PlayItem includes timing information for a play start time (In-Time) and a play end time (Out-Time) of a clip designated as a clip name (Clip_Information_File_name) within the PlayItem. Hence, the playlist file (*.mpls) is basic reproduction control information for at least one or more main AV clips.

Moreover, the playlist file (*.mpls) may further include SubPlayItems. A SubPlayItem includes basic reproduction control information for, for example, a text subtitle stream file.

If a SubPlayItem to reproduce at least one text subtitle stream file is provided within a playlist file, the SubPlayItem should be synchronized with PlayItem. On the other hand, in case that the SubPlayItem is provided to present a browsable slideshow, the SubPlayItem does not have to be synchronized with PlayItem.

In the present invention, a major function of the SubPlayItem lies in controlling a reproduction of at least one text subtitle stream file.

In the playitem, there is a STN_table that lists the reproducing streams that may be reproduced during a Playing interval, and one of entries in STN_table is selected for reproducing. The STN_table includes video streams, audio streams, text subtitle streams, etc.

Finally, the auxiliary data directory “AUXDATA” includes supplementary data stream files. For instance, the supplementary data stream files may be a ‘font file’ (e.g., ‘aaaaa.font’ or ‘aaaaa.otf’), ‘pop-up menu file’ (not shown in the drawing), or ‘sound file’ (sound.bdmv) for providing a click sound. In particular, the aforesaid text subtitle stream file can be included in the auxiliary data directory instead of being included in the stream directory.

FIG. 3 is a diagram of a data storage area within an optical disc according to an embodiment of the present invention.

Referring to FIG. 3, an optical disc includes a file system information area occupying a most inner circumference of a disc volume, a stream area occupying a most outer circumference of the disc volume and a database area occupying an area between the file system information area and the stream area.

And, system information, as shown in FIG. 2, for managing an entire data file is stored within the database area.

Moreover, main data and supplementary data (e.g., a plurality of AV streams and at least one or more text subtitle streams) are stored within the stream area. The main data includes audio data, video data and graphic data. The supplementary data (e.g., text subtitle) is not multiplexed with the main data but is independently stored within the stream area.

The aforesaid general files, playlist files and clipinfo files, as shown in FIG. 2, are stored within the database area of the disc volume. The text subtitle of the embodiment of the present invention is included in the supplementary data stored in the stream area.

As mentioned in the foregoing description, the general files include an index file and an object file. And, the playlist file and the clipinfo file include information for reproducing AV streams and text subtitle streams stored within the stream area. In particular, a user is able to select a specific reproduction mode by utilizing the information stored within the database area and/or the stream area. And, the main AV and text subtitle streams are reproduced within the selected reproduction mode. Yet, the respective areas shown in FIG. 3 are just exemplary. And, it is apparent that the present invention is not limited to the area arrangement shown in FIG. 3.

A detailed structure of a text subtitle stream of the present invention is explained as follows.

First, management information for reproducing a text subtitle is newly defined. A method of configuring a text subtitle stream including the newly defined management information, a method of reproducing a text subtitle to reproduce a recorded stream file and apparatus thereof are explained in detail.

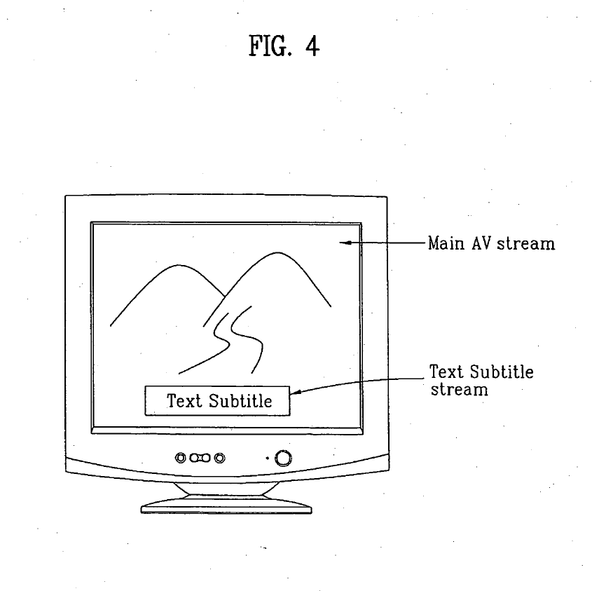

FIG. 4 is a diagram of a text subtitle and a main image displayed on a display screen according to an embodiment of the present invention, in which if a text subtitle stream corresponding to a main AV stream is synchronized to be reproduced, a main image and a text subtitle are simultaneously displayed on a display screen.

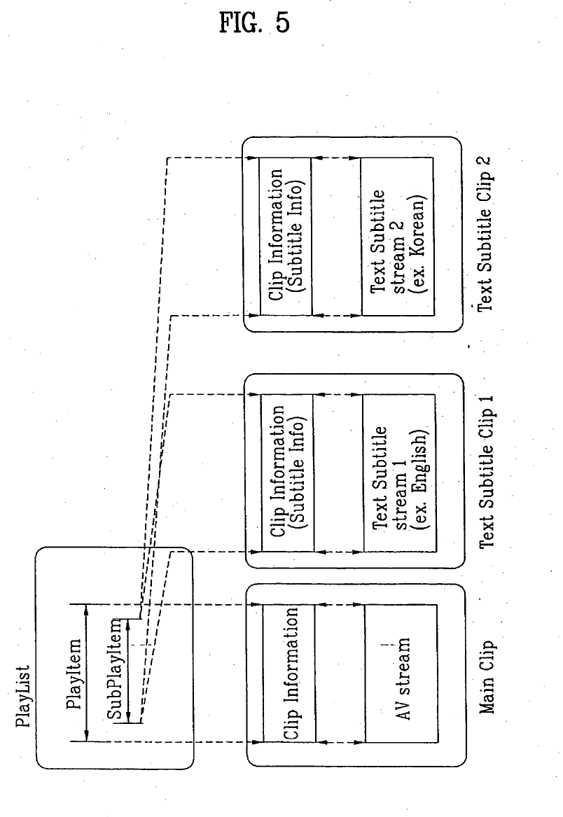

FIG. 5 is a diagram of a structure for reproduction management of a text subtitle stream according to an embodiment of the present invention.

Referring to FIG. 5, a playlist file includes at least one playitem for reproduction management of at least one AV clip file and a subplayitem for reproduction management of a plurality of text subtitle clips.

For instance, a text subtitle clip 1 and a text subtitle clip 2 are an English subtitle and a Korean subtitle, respectively. Generally, one of the text subtitle clip 1 and the text subtitle clip 2, which are temporally synchronized with main AV data, will be displayed on a screen together with the main AV data at a specific presentation time.

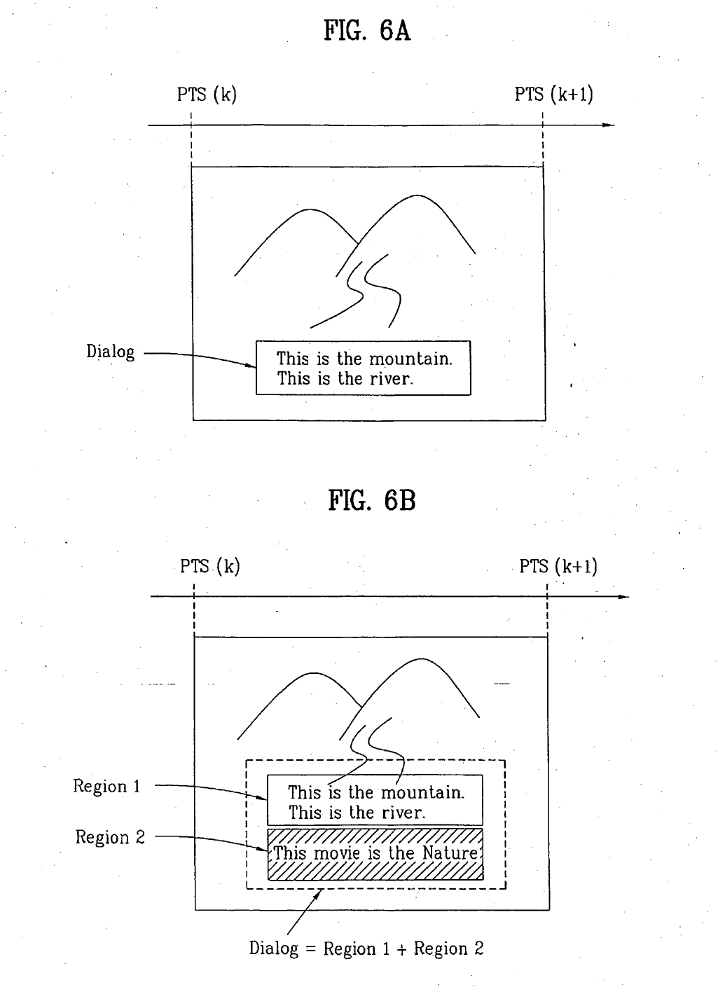

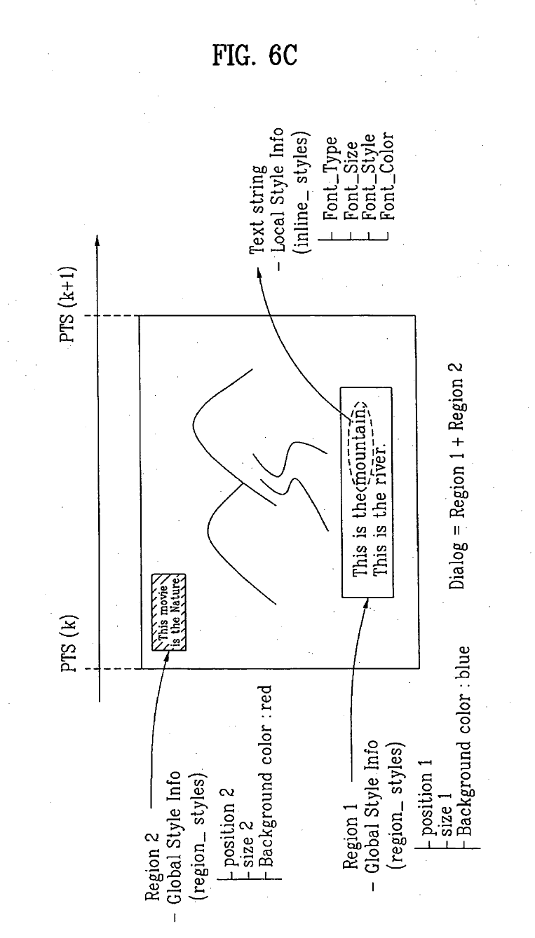

In order to display a text subtitle on a screen, reproduction management information (e.g., position information, size information) and presentation time information, as shown in FIG. 6A and FIG. 6C, are provided.

FIG. 6A shows ‘dialog’ as information for reproduction management of a text subtitle according to an embodiment of the present invention.

Referring to FIG. 6A, ‘dialog’ means all text subtitle data displayed within a specific presentation time. Generally, a presentation time of dialog is represented PTS, (presentation time stamps).

For instance, a presentation of the dialog shown in FIG. 6A starts from PTS(k) and ends at PTS(k+1). Hence, the dialog shown in FIG. 6A indicates text subtitle data presented between PTS(k) and PTS(k+1). And, one dialog within one text subtitle includes a maximum of one hundred character codes.

FIG. 6B shows a plurality of regions of dialog according to an embodiment of the present invention.

Referring to FIG. 6B, ‘region’ represents a segmented portion of text subtitle data (dialog) displayed within a specific presentation time. In particular, one dialog includes at least one or more regions and each of the regions may include at least one subtitle text line.

The entire text subtitle data are displayed on a screen according to a region style or global style allocated to each of the regions.

A maximum number of regions included in one dialog should be determined based on a desirable decoding rate of subtitle data. This is because too many regions may bring about a low decoding rate.

For instance, to achieve a high-efficiency decoding rate, a maximum number of regions included in one dialog should be limited to 2.

In case of reproducing a text subtitle stream, a maximum number of regions included in one dialog should be limited to 2 to consider a decoding load. Alternatively, it is also possible to set a maximum number (n) of regions included in one dialog to ‘n>2’.

FIG. 6C shows style information for regions within a dialog according to an embodiment of the present invention.

Referring to FIG. 6C, ‘style information’ is the information defined an attribute for displaying at least one of the regions included in a dialog. As an example of the style information, there is a position, size, background color, text alignment, text flow or the like. And, the style information can be classified into region style information (global style information) and inline style information (local style information).

The region style information means a region or global style applied to one entire region within a dialog. For instance, the region style information includes at least one of region position, region size, font color, background color, text flow, text alignment, line space, font type, font style and font size.

For instance, two different region styles, as shown in FIG. 6C, are applicable to region 1 and region 2, respectively. Namely, position 1, size 1 and blue color become style information applied to the region 1, whereas position 2, size 2 and red color become style information applied to the region 2.

On the other hand, the inline style information means inline or local style information applied to a portion of a specific text string included in one region. For instance, the inline style information includes at least one of font type, font size, font style and font color. A specific portion of the text string can become an entire text line within one region or a specific portion of a text line.

In FIG. 6C, it can be known that a specific inline style is applied to ‘mountain’ corresponding to a portion of a text of the region 1. Namely, at least one of the font type, font style and font color applied to the specific portion of the text string becomes different from that of the rest of the text string.

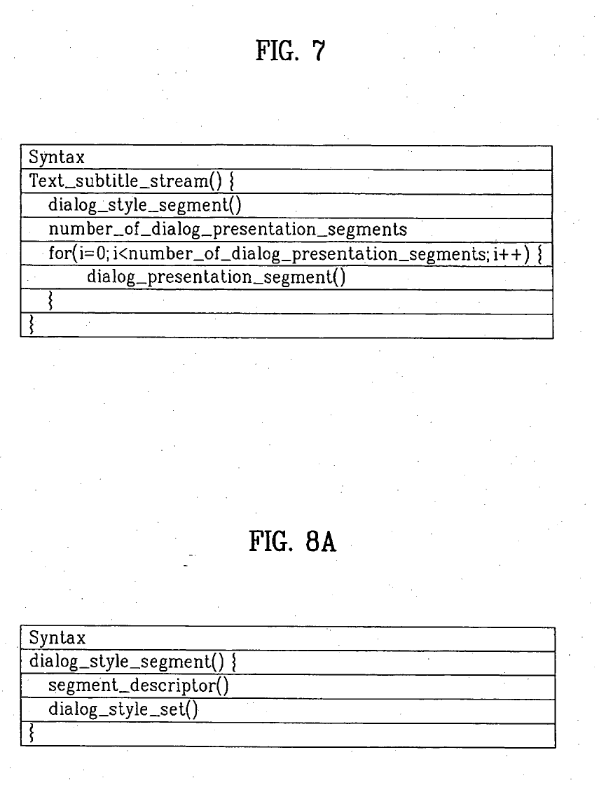

Syntax of dialog style segment (DSS) and syntax of dialog presentation segment (DPS) are explained in detail with reference to FIGS. 7 to 9C as follows.

FIG. 7 is an exemplary diagram of syntax of a text subtitle stream (“Text_subtitle_stream( )”) according to an embodiment of the present invention.

Referring to FIG. 7, “Text_subtitle_stream( )” includes “dialog_style_segment( )” syntax, and a “dialog_presentation_segment( )” syntax for each of a number_of_dialog_presentation_segments.

In particular, the “dialog_style_segment( )” syntax relates to one dialog style segment (DSS) defining a region style (region_style). And, the “dialog_presentation_segment” syntax relates to a plurality of dialog presentation segments (DPS) used in transmitting data associated with a dialog object.

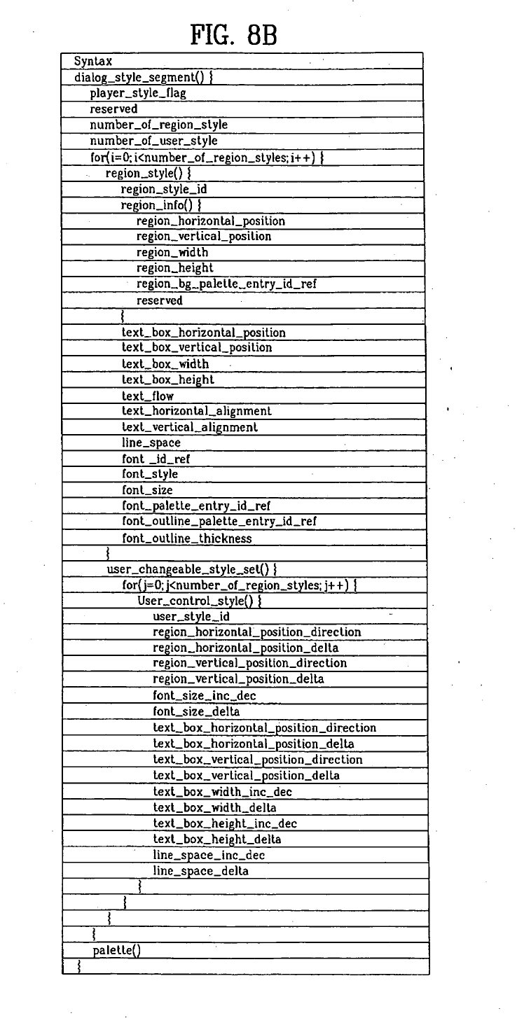

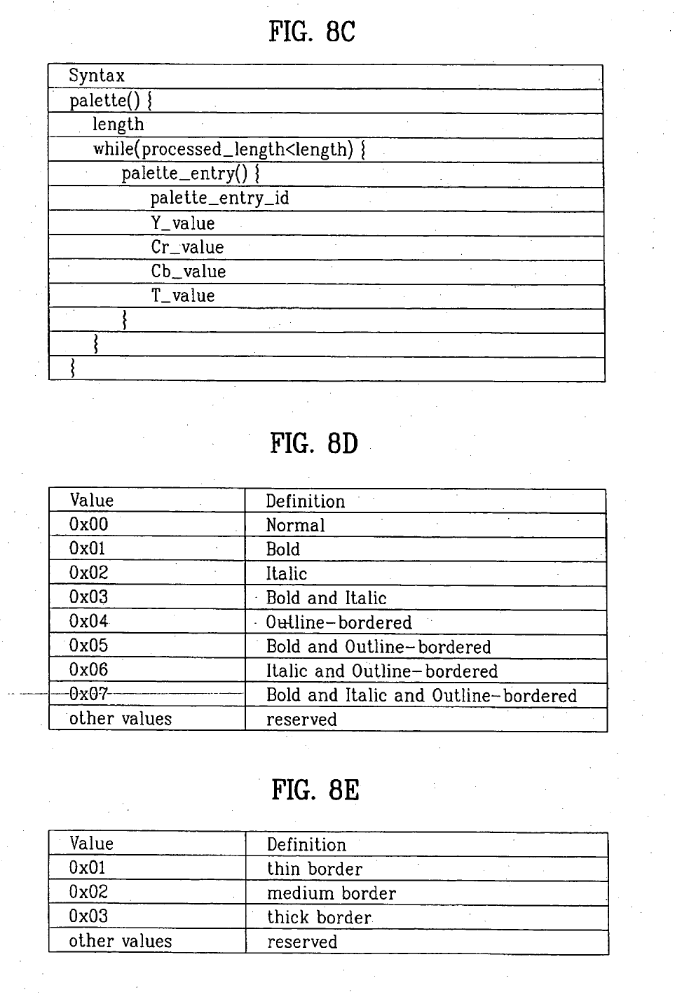

FIGS. 8A to 8E are detailed diagrams of a “dialog_style_segment( )” indicating a dialog style segment (DSS) according to an embodiment of the present invention.

FIG. 8A shows an overall configuration of the “dialog_style_segment( )”.

Referring to FIG. 8A, a “dialog_style_set( )” defining various style information used in a dialog is included in the “dialog_style_segment( )”.

FIG. 8B shows the “dialog_style_set( )” defined within “dialog_style_segment( )”.

Referring to FIG. 8B, a player style flag (“player_style_flag”), a user changeable style set (“user_changeable_style_set”) and a palette information (“palette( )”) are included in “dialog_style_set( )” as well as the region style information (“region_style( )”).

The “player_style_flag” is information indicated by a disc author to represent whether style information possessed by a player may be applied. For instance, if “player_style_flag=1b”, a player is allowed to reproduce a text subtitles using style information provided within the player itself as well as style information defined by a “dialog_style_set( )” within a disc. On the other hand, if “player_style_flag=0b”, the style information defined by a “dialog_style_set( )” within the disc can be utilized only.

The region style information (“region_style”) means “global style information” defined per region. Identity information (“region_style_id”) is given to each region style information respectively and a style information set corresponding to a specific “region_style_id” is defined.

So, in case of attempting to present a corresponding dialog by recording “region_style_id” applied to the dialog within a dialog presentation segment (DPS), the presentation is achieved by applying a value of a style information set defined as the same “region_style_id” within “dialog_style_set”.

Individual style information included in the style information set provided to each “region_style_id” is explained as follows.

First, as information for defining a position and size within a screen of a corresponding region, “region_horizontal_position”, “region_vertical_position”, “region_width” and “region_height” are provided. The “region_horizontal_position” and the “region_vertical_position” define the position of the upper left hand corner of the region. And, “region_bg_palette_entry_id” is provided to determine a background color of a corresponding region.

As information for defining a position and size of a text box within a corresponding region, “text_box_horizontal_position”, “text_box_vertical_position”, “text_box_width” and “text_box_height” are provided. The “text_box_horizontal_position” and the “text_box_vertical_position” define the position of the upper left hand corner of the text box.

And, “text_flow” defining a write direction (left→right, right→left, top→bottom) of a text within a corresponding region relative to the present invention and “text_horizontal_alignment” & “text_vertical_alignment” defining an alignment direction (left, center, right) including a start position of a text are provided.

In particular, if a plurality of regions exist within a specific dialog, each of the regions within the corresponding dialog may be defined to have a same value of “text_flow”. This is to prevent user's viewing confusion and the like.

As individual style information included in a style information set, “line_space” indicating a space between respective lines within a region is provided.

As font information for real text data, “font_id”, “font_style”, “font_size”, “font_palette_entry_id”, “font_outline_palette_entry_id” and “font_outline_thickness” are provided. They are explained in detail as follows.

First of all, a value of “font_id” is used to designate or identify a font file, and is defined by “ClipInfo( )” associated with a clip AV stream file including the dialog style set (“dialog_style_set( )”).

The “font_style” is used to designate a style of font. Values of the “font_style”, as shown in the table of FIG. 8D, include values designating Bold, Italic, outline-bordered styles and their complex styles. In this case, an outline-border means an outline of a letter. If the “font_style” value designates an outline-border, “font_outline_palette_entry_id” and “font_outline_thickness” designating color and thickness are separately defined for a corresponding outline. This is explained in detail in the following description.

The “font_size” is used to designate a size of font and the “font_palette_entry_id” designates a palette entry number for a color of text in the “palette( )”.

The “font_outline_palette_entry_id” is used to indicate a color of the outline-border if the outline-border is designated by the “font_style”. And, the “font_outline_palette_entry_id” designates an entry number in palette O for a color of the outline-border.

The “font_outline_thickness” is used to indicate thickness of the outline-border if the outline-border is designated by the “font_style”. In a table exemplary shown in FIG. 8E, there are thin border, medium border and thick border options according to a value of the “font_outline_thickness”.

Meanwhile, “user_changeable_style_set( )” relative to the present invention is explained as follows.

First of all, the “user_changeable_style_set( )” is utilized in facilitating a user to change style information of text subtitle data by defining a type and changeable range of user-changeable style information in advance. Yet, if the above-explained entire style information is changeable by a user, it is highly probable that user's confusion may increase.

So, in the present invention, it is defined that “font_size” and “region_position” are changeable. And, it is also defined that a position and size of a “text_box” may be changed according to increment/decrement of the “font_size”. Moreover, a change of “line space” is defined within the “user_changeable_style_set( )”.

Besides, it is possible to define about a maximum of 25 kinds of user style IDs (“user_style_id”) within the “user_changeable_style_set( )”. In this case, the user style ID (“user_style_id”) is used to identify a user style applied to a dialog presentation segment.

And, “region_horizontal_position_direction” and “region_vertical_position_direction” are included per “user_style_id” to designate change moving directions of “region_horizontal_position” and “region_vertical_position”, respectively. The “region_horizontal_position_delta” and the “region_vertical_position_delta” information are included to designate a 1-time change portion by pixel unit in each direction.

For instance, if a value of the “region_horizontal_position_direction” is ‘0’, it means that a position of a region is moved in a right direction. If a value of the “region_horizontal_position_direction” is ‘1’, it can be defined that a position of a region is moved in a left direction. If a value of the “region_vertical_position_direction” is ‘0’, it means that a position of a region is moved in a downward direction. If a value of the “region_vertical_position_direction” is ‘1’, it can be defined that a position of a region is moved in an upward direction.

And, “font_size_inc_dec” information designating a change direction of the “font_size” and “font_size_delta” information designating a 1-time change portion of the “font_size” by pixel unit are included.

For instance, if a value of “font_size_inc_dec” is ‘0’, it means that a size of font increases. If a value of “font_size_inc_dec” is ‘1’, it means that a size of font decreases.

Similarly, the same method of changing the “region_position” is applicable to define a changing method of “text_box_horizontal_position_direction”, “text_box_horizontal_position_delta”, “text_box_vertical_position_direction” and “text_box_vertical_position_delta”, which indicate an increase/decrease of a position of a text box changed according to the increase/decrease of the “font_size”.

And, the same method of changing the “font_size” is applicable to define a method of changing “text_box_width_inc_dec”, “text_box_width_delta”, “text_box_height_inc_dec” and “text_box_height_delta”, which indicate an increase/decrease of a size of the text box.

Moreover, the same method of changing the “font_size” is applicable to define a method of changing “line_space_inc_dec” and “line_space_delta”, which indicate an increase/decrease of a line space.

The features of the “user_changeable_style_set( )” are explained as follows.

First, user control styles (“user_control_style( )”) amounting to the same number of regions styles (“region_style( )”) defined within dialog style segment (DSS) are defined. Hence, the number of the user control styles (“user_control_style( )”) applicable within all dialog presentation segments (DPS) is identical.

Each of the user control styles (“user_control_style( )”) is identified by a different “user_style_id”. Hence, if a user selects a specific “user_style_id”, the “user_style_id” of the user control style (“user_control_style( )”) is identically applied to all region styles.

A combination of all changeable styles is defined within one “user_control_style( )” together. For instance, region position (“region_position”) and font size (“font_size”) are simultaneously defined together instead of being separately defined.

Finally, information for indicating each direction (*_direction) and increase/decrease (*_inc_dec) separate from a position change unit (*_delta) is independently recorded. In particular, by defining the position change unit (*_delta) only, a final value of the actually changed style information is found by adding the position change unit (*_delta) to a value defined within the region style (“region_style( )”).

FIG. 8C shows palette information (“palette( )”) defined within the “dialog_style_set( )” of the present invention.

Referring to FIG. 8C, the palette information (“palette( )”) provides color change information of text subtitle data recorded within dialog. Namely, “palette( )” is constructed with a plurality of palette entries (palette_entry). Each of the palette entries (palette_entry) is identified by a corresponding palette entry ID (palette_entry_id). And, each of the palette entries (palette_entry) provides an intrinsic brightness value (Y_value), an intrinsic color value (Cr_value, Cb_value) and intrinsic “T_value” which designates transparency of text data.

One of the features of the text subtitle stream according to the present invention lies in defining one basic (common) palette information and applying the palette information to each dialog presentation segment (DPS) included in a text subtitle stream file.

In particular, after the palette information has been defined within dialog style segment (DSS), the defined palette information is used by all dialog presentation segments (DPS) in common. Yet, in case of attempting to use new intrinsic palette information instead of using the common palette information within the dialog style segment (DSS), the new intrinsic palette information should be newly defined using “palette_update_flag”.

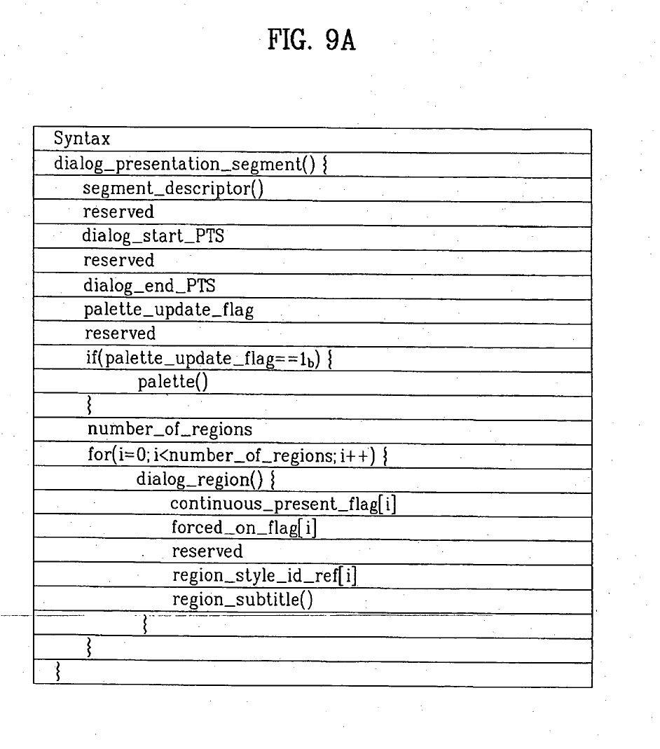

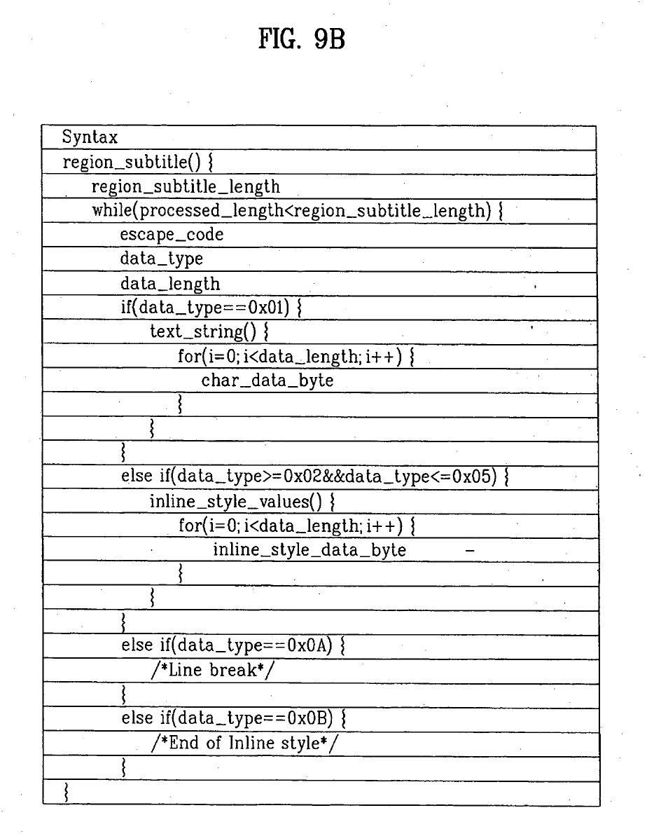

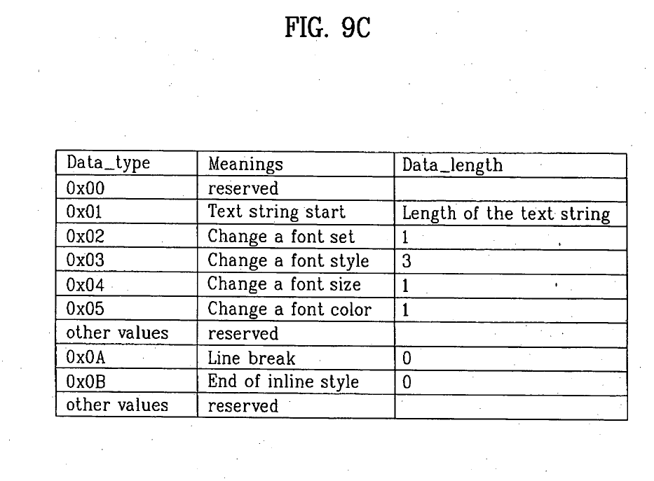

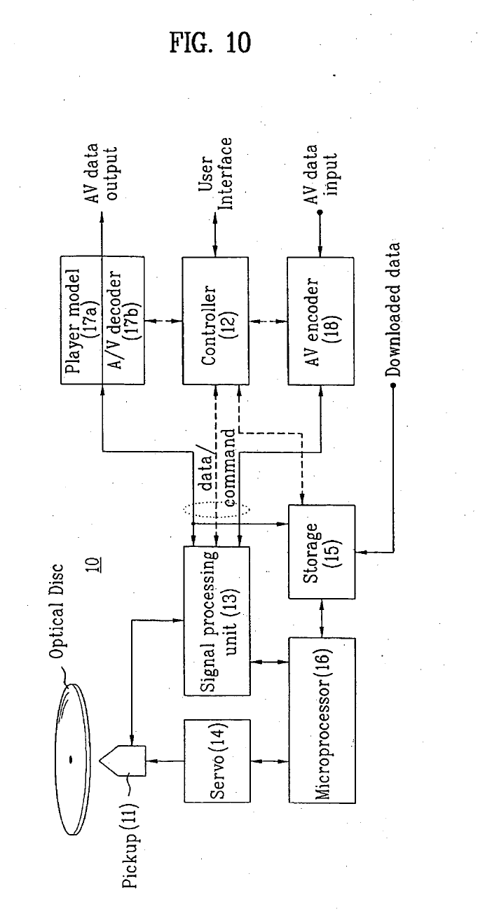

FIGS. 9A to 9C are detailed diagrams of “dialog_presentation_segment( )” meaning a dialog presentation segment (DPS).

FIG. 9A shows an overall structure of a “dialog_presentation_segment( )” according to an embodiment of the present invention.

Referring to FIG. 9A, “dialog_start_PTS” and “dialog_end_PTS” designating a presentation time of a corresponding dialog are defined within “dialog_presentation_segment( )”.

Subsequently, “palette_update_flag” representing whether or not to change color information within a corresponding dialog is included. Namely, if a value of the “palette_update_flag” is ‘1b’, color information and transparency information are changed. So, palette information (“palette( )”) designating a new color is independently recorded. In this case, the palette information (“palette( )”) is newly defined within a dialog presentation segment (DPS) and should be applied to the corresponding dialog presentation segment (DPS) only. If a value of the “palette_update_flag” is ‘0b’, the common palette information (shown in FIG. 8C) defined within the aforesaid dialog style segment (DSS) is sustained to utilize in presenting the corresponding dialog presentation segment (DPS).

And, “dialog_region( )” defining region information for each of a number_of_regions is recorded with the “dialog_presentation_segment( )”. Since maximum two regions are provided within one dialog according to an embodiment of the present invention, “dialog_region( )” is provided to each of the regions.

In the “dialog_region( )”, “region_style_id_ref” information and “continuous_present_flag” information are included. The “region_style_id_ref” information designates one of the regions styles (style information) explained in FIG. 9B and the “continuous_present_flag” information is recorded to identify a presence or non-presence of an execution of a seamless reproduction with a previous dialog region.

In the “dialog_region( )”, text data and “region_subtitle( )” information are included. The text data is substantially included within the corresponding region information of the “region_subtitle( )” and the “region_subtitle( )” also includes information defines local style information.

The “region_subtitle( )” is explained in detail with reference to FIG. 9B and FIG. 9C as follows.

First, the “region_subtitle( )” includes a text string and identification information (i.e., “data_type”) identifying inline style information (“inline_styles”) applied to the text string. And, 1-byte information (i.e., “escape_code”) is recorded between information identified by the identification information (data₁₃ type). Furthermore, within the “region_subtitle( )”, the text string and the inline style information (inline styles) are recorded and the identification information (“data_type”) identifying the inline style information and length of information (“data_length”) are included.

If a value of the “data_type” is ‘0x01’, it is defined to mean a text string. If a value of the “data_type” is ‘0x01’, a text string is recorded as a character code in a specific field (“char_data_byte”) within “text_string( )”. In other words, the “char_data_byte” is used to record such a text data as “mountain” shown in FIG. 6C.

And, the “text_string” indicates continuity of an encoded character code according to “character_code” defined in “StreamCodingInfo” of a relative clip information file.

If a value of the “data_type” is ‘0x02’˜‘0x05’, it is defined to mean the inline style information (inline styles). The inline style information (inline styles) is constructed with at least one inline style type (inline_style_type).

For instance, if a value of “inline_style_type” is ‘0x02’, it means a change of a font set and a font ID value designated by a relative ClipInfo is recorded in a specific field (“inline_style_data_byte”).

If a value of “inline_style_type” is ‘0x03’, it means a change of a font style and a corresponding font style value is recorded in a specific field (“inline_style_value”, “font_outline_palette_entry_id_ref”, “font_outline_thickness”).

If a value of “inline_style_type” is ‘0x04’, it means a change of a font size and a corresponding font size value is recorded in a specific field (“inline_style_data_byte”).

If a value of “inline_style_type” is ‘0x05’, it means a change of a font color and an index value designated in a relative palette is recorded in a specific field (“inline_style_data_byte”).

If a value of “inline_style_type” is ‘0x0A’, it means a line break. This means that a line should be changed for a reproduction in decoding a text subtitle without recording additional data.

If a value of “inline_style_type” is ‘0x0B’, it means an end of inline style and indicates that all inline styles are reset to default value of a region style. In particular, “region_style( )” defined by “region_style_id_ref” is applied to a text string after the end.

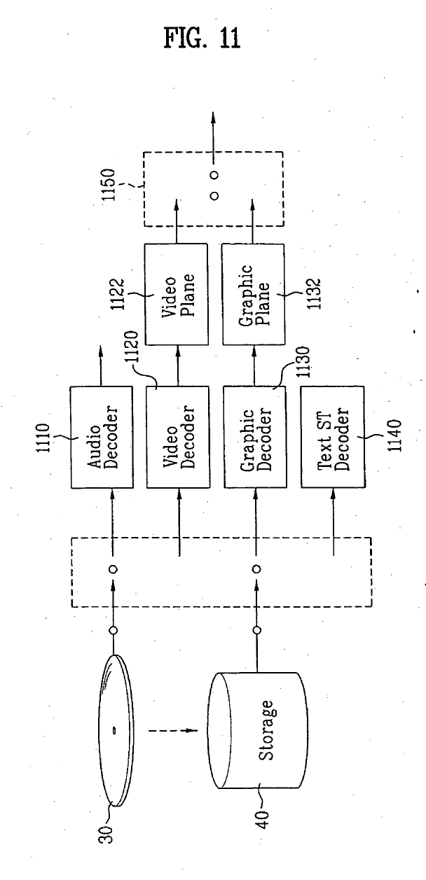

A method and apparatus for reproducing the text subtitle stream file according to an embodiment of the present invention are explained with reference to FIGS. 10 to 14 as follows.

FIG. 10 is a block diagram of an overall configuration of an optical record player 10 according to an embodiment of the present invention.

Referring to FIG. 10, an optical record player 10 according to one embodiment of the present invention basically includes a pickup 11 for reproducing management information including original data and reproduction management file information recorded in an optical disc; a servo 14 controlling an action of the pickup 11; a signal processing unit 13 restoring a reproduction signal received from the pickup 11 to a specific signal value, and modulating a signal to be recorded into a signal recordable on the optical disc; and a microprocessor 16 controlling the overall operations.

Additional data existing other than on an optical disc is downloaded to a controller 12 according to a user command or the like. And, the controller 12 enables the downloaded data to be stored in a storage 15. The controller 12 reproduces original data and/or additional data within the storage 15 according to a user's request.

A playback system 17 finally decodes output data to provide to a user under the control of the controller 12. The playback system 17 includes an AV decoder 17b decoding an AV signal. The playback system 17 further includes a player model 17a deciding a play direction by analyzing an object command or application associated with the aforesaid playback of a specific title and a user command inputted via the controller 12.

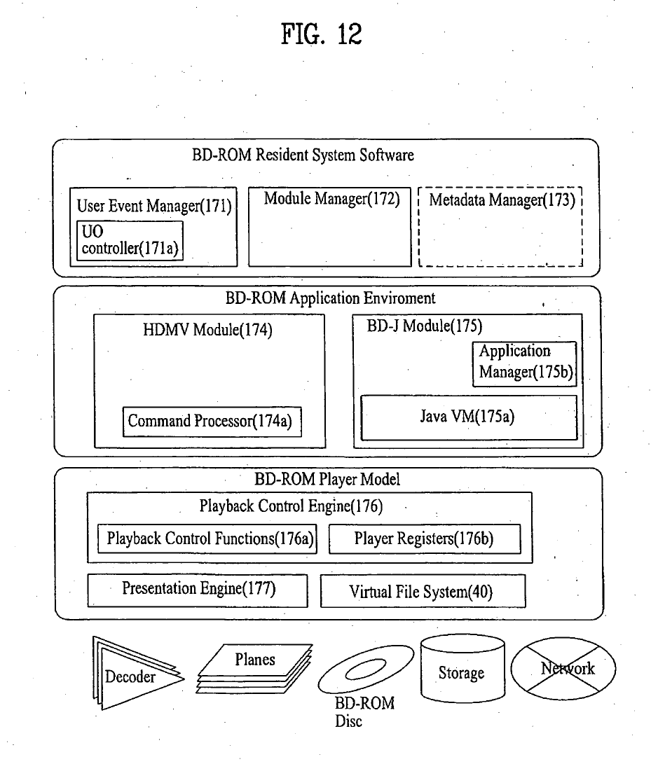

In the present invention, the control unit 12 can control a text subtitle stream and control the decoded text subtitle to be reproduced according to reproduction possibility information stored in the playback system 17. The playback system 17 will be explained in detail with reference to FIG. 12 later.

To perform a function of recording a signal on an optical disc, the AV encoder 18 converts an input signal to a signal of a specific format, e.g., an MPEG2 transport stream according to a control of the controller 12 and then provides the converted signal to the signal processing unit 13.

FIG. 11 is a schematic block diagram of a playback system according to an embodiment of the present invention, in which a reproduction of a text subtitle stream file is included. FIG. 11 mainly shows a decoder of an optical disc player according to an embodiment of the present invention, and more particularly, an example that a decoder for a reproduction of a text subtitle is separately is provided.

Referring to FIG. 11, a decoder according to an embodiment of the present invention includes an audio decoder 1110 decoding an audio stream, a video decoder 1120 decoding a video stream, a graphic decoder 1130 decoding a graphic stream and a text decoder (Text ST decoder) 1140 decoding a text subtitle stream.

A text subtitle according to the present invention can be extracted from an optical disc 30 or a storage 40. The text subtitle extracted from the optical disc 30 or the storage 40 is decoded by the text decoder 1140.

And, a playback system according to the present invention further includes a video plane 1122 converting a signal decoded by the decoder to a displayable image and a graphic plane 1132. The decoded video and text subtitle decoded by the video decoder 1120 and the text decoder 1140, respectively, are converted by the video plane 1122 and the graphic plane 1132, respectively.

The playback system further includes an image synthesizing unit 1150 synthesizing signals outputted from the video and graphic planes 1122 and 1132 together. The video and text subtitle converted by the video and graphic planes 1122 and 1132 are synthesized by the image synthesizing unit 1150 and are then displayed on a display unit 20. In particular, a video image outputted from the video plane 1122 becomes a background on the display unit and an image outputted from the graphic plane 1132 is overlapped on the video image.

FIG. 12 is a block diagram of a data reproducing apparatus utilizing a playback system according to an embodiment of the present invention.

A playback system reproducing stream data decoded by the aforesaid decoder is mainly explained with reference to FIG. 12 as follows.

Referring to FIG. 12, first of all, “playback system” includes a collection of reproduction processing means implemented as a program (software) and/or hardware provided within an optical record player. The playback system plays a record medium loaded in the optical record player and simultaneously reproduces and manages the data that is associated with the record medium and is stored in a storage (e.g., data downloaded from outside).

In particular, a playback system 17 includes “User Event Manager (171)”, “Module Manager (172)”, “Metadata Manger (123)”, “HDMV Module (174)”, “BD-J Module (175)”, “Playback control engine (176)”, “Presentation engine (177)” and “Virtual File System (40)”, which are explained in detail as follows.

First of all, as separate reproduction processing management means for reproducing HDMV Titles and BD-J Titles, respectively, the “HDMV Module (174)” for HDMV Title and the “BD-J Module (175)” for BD-J Title are independently configured. Each of the “HDMV Module (174)” and the “BD-J Module (175)” has a control function of receiving to process a command or program within the aforesaid object (Movie Object or BD-J Object). The “Metadata Manager (173)” is able to perform a title selection and to provide a recording medium and title metadata to a user at any time under a user's control. The “HDMV Module (174)” and the “BD-J Module (175)” enable a portability of a command or application by separating the command or application from a hardware configuration of the playback system. As a means for receiving to process the command, application or the like, a “Command processor (174a) is provided within the “HDMV Module (174) and a “Java VM (175a)” and an “Application manager (175b)” are provided within the “BD-J Module (175).

The “Java VM (175)” is a “Virtual Machine” executing an application. The “Application manager (175b)” includes an application management function of managing a lifecycle of an application.

Moreover, the “Module Manager (172)” is provided to deliver a user command to the “HDMV Module (174)” or the “BD-J Module (175)” and to control an operation of the “HDMV Module (174)” or the “BD-J Module (175)”.

The “Playback control Engine (176)”, which interprets PlayList file information recorded within a disc according to a reproduction command of the “HDMV Module (174)” or the “BD-J Module (175)” and performs a corresponding reproduction function, is provided. Moreover, the “Presentation Engine (177)” for decoding a specific stream reproduced and managed by the “Playback Control Engine (176)” and displaying the decoded stream on a screen, is provided. Specifically, the “Playback Control Engine (176)” includes “Playback Control functions (176a)” actually managing all reproductions and “Player Registers (176b)” storing player status registers (PSR) and general purpose registers (GPRs). In some cases, the “Playback Control functions (176a)” may mean a “Playback Control Engine (176)”.

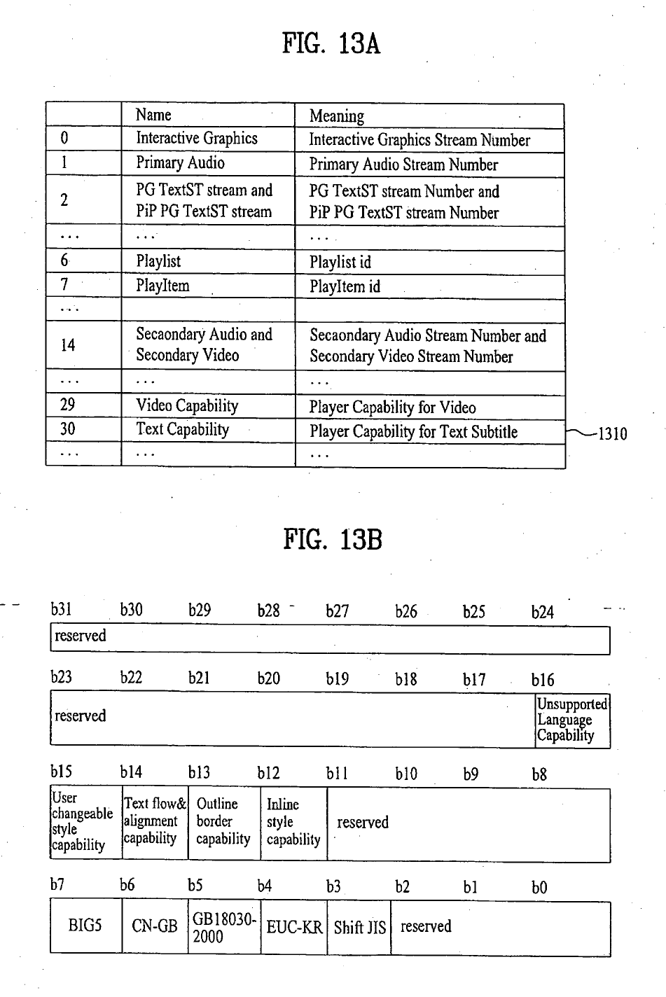

In the present invention, the “Player registers (176b)” becomes a memory unit indicating a playback status of the secondary video. And, the memory unit will be explained in detail with reference to FIG. 13 later.

HDMV title and BD-J title receive user commands in separate types, respectively, and independently perform the user commands. A means for receiving and delivering a user command to either “HDMV Module (174)” or “BD-J Module (175)” is provided, which is handled by a “User Event Manager (171)”. So, if a received command is a user command by the “User Operation (UO)”, the “User Event Manager (171)” transfers it to the “Module Manager (172)” or the “UO controller (171a) to perform the user command. If a received command is a user command by “Key Event”, the “User Event Manager (171)” transfers it to the “Java VM (175a)” within the “BDD-J Module (175)” to perform the user command.

And, the playback system 17 according to the present invention can include the “Metadata Manager (173)” that provides disc library and enhanced search metadata applications to a user.

In the above-explained playback system of the present invention, the “Module Manager (172)”, “HDMV Module (174)”, “BD-J Module (175)” and “Playback Control Engine (176)” may be implemented by software processing, respectively. Substantially, software processing is more advantageous than a hardware configuration in design. Yet, the “Presentation Engine (177)”, decoder and planes (video, graphic, etc.) are normally designed in hardware. In particular, the elements (e.g., reference numbers 172, 174, 175, 176) implemented by software can be configured as a portion of the controller 12. Hence, the configuration of the present invention should be understood by its meaning but is not limited to a hardware configuration or a software configuration.

FIG. 13A is an exemplary diagram of a status memory unit provided in a reproducing apparatus according to an embodiment of the present invention, and FIG. 13B is an exemplary diagram of PSR30 as a part of the status memory unit shown in FIG. 13A. The PSR30, which stores information for reproduction possibility of a text subtitle, is explained in detail as follows.

First, an optical record player 10 includes “Player Registers (176b)” as memory units storing information for record playback status and an environment of the player. The “Player Registers (176b)” can be divided into “General purpose Registers (GPRs)” and “Player Status Registers (PSRs)”.

The “Player Status Registers (PSRs)” can be divided into “Playback Status Registers” storing playback status parameters (e.g., ‘interactive graphics stream number’ and ‘primary audio number’) and “Player Setting Registers” storing optical record player configuration parameters.

Reproduction possibility information relative to a reproduction of a text subtitle of the present invention can be stored in “PSR30” 1310 corresponding to one of the “Player Setting Registers”. The features of the “Player Setting Registers” are explained as follows.

First, a value included in the “Player Setting Registers” cannot be changed by a navigation command. In BD-J application, for example, in case that Java application makes a recording in “Player Setting Registers”, the BD-ROM player may or may not approve a decision of the application. So, it is able to change the value included in the “Player Setting Registers” indirectly.

If a disc is loaded in BD-ROM player, initiation is executed. In this case, the initiation is performed on the entire “Player Setting Registers”. Yet, at least one of the “Player Setting Registers” of this embodiment of the present invention is not affected by this initiation. This is because the “Player Setting Register” stores information indicating whether the BD-ROM player supports a reproduction of relative data. Yet, data relative to the information for the reproduction support can be inputted from an external input source according to features of the BD-ROM player.

Referring to FIG. 13A, PSR30 (“Text Capability”) as one of “Player Status Registers (PSRs)” stores information for a presence or non-presence of reproduction possibility of a player relative to a text subtitle.

Referring to FIG. 13B, style function information of text subtitle and information of text format are separately stored in PSR30. For instance, the PSR30 includes “Unsupported Language Capability”, “User changeable style set capability”, “Text flow & alignment capability”, “Outline border capability” and “Inline style capability” fields indicating the style function information of the text subtitle. And, the PSR30 includes “BIG5”, “CN-GB”, “GB18030-2000”, “EUC-KR’ and “Shift_JIS” fields indicating a presence or non-presence of support for the text format. Moreover, the PSR30 may include “User changeable palette capability” field in some cases.

The “Unsupported Language Capability” represents information indicating whether a text subtitle not supported by a BD-ROM player is allowed to be selected by a user operation, navigation command or application programming interface (BD-J API).

If a value of the “Unsupported Language Capability” is ‘0_{b}’, it means ‘not allowed’. If a value of the “Unsupported Language Capability” is ‘1_{b}’, it means ‘allowed’. For instance, if a value of the “Unsupported Language Capability” is ‘0_{b}’, it is unable to reproduce a corresponding text subtitle in case that it is not reproducible by a player. On the other hand, if a value of the “Unsupported Language Capability” is ‘1_{b}’, it is able to achieve a reproduction into a style different from a previous style recorded by an author in manufacturing although a function is not supported by the reproduction possibility information stored in the PSR30.

The “User changeable style set capability” represents information indicating whether values associated with the region and text included in the “User control style” included in the “user changeable style set” shown in FIG. 8B are supportable by a player. In this case, if a value of the “User changeable style set capability” is ‘0_{b}’, it means ‘not allowed’. If a value of the “User changeable style set capability” is ‘1_{b}’, it means ‘allowed’.

For instance, in case that a value of the “User changeable style set capability” is ‘0_{b}’, it is unable to change a region's position, font size, position or size of text box and line space by a user. So, even if it is defined in the “user_changeable_style_set” that the region's position, font size, position or size of text box and line space are changeable, the change cannot be made since it is not supported by the player. On the other hand, in case that a value of the “User changeable style set capability” is ‘1_{b}’, it is able to change a region's position, font size, position or size of text box and line space by a user.

The “Text flow & alignment capability” indicates a restriction for “text flow” and “text alignment” included in the “region style” shown in FIG. 8B. In this case, if a value of the “Text flow & alignment capability” is ‘0_{b}’: (1) A text flow proceeds left to right (Left-to-right character text flow) and text alignment corresponds to top & left alignment; or (2) A text flow proceeds right to left (Right-to-left character text flow) and text alignment corresponds to top & right alignment only. On the other hand, if a value of the “Text flow & alignment capability” is ‘1_{b}’, all kinds of text flows and alignments are possible.

The “Outline border capability” represents information indicating whether a display of an outline border is possible in reproducing text represented as an outline border in case that the “font style” included in the “region style” shown in FIG. 8B includes the outline border. In this case, if a value of the “Outline border capability” is ‘0_{b}’, a reproduction of the outline border is impossible. On the other hand, if a value of the “Outline border capability” is ‘1_{b}’, a reproduction of the outline border is possible.

For instance, if a value of the “Outline border capability” is ‘0_{b}’, a user is unable to view an outline border since the player does not support the outline border despite that a font style is defined to include the outline border. On the other hand, if a value of the “Outline border capability” is ‘1_{b}’, in case that a font style included in a text subtitle stream includes an outline border, the outline border can be represented according to a color or thickness of an outline border defined by the “font_outline_palette_entry_id_ref” and “font_outline_thickness” included in the region style (“region_style( )”) exemplarily shown in FIG. 8B.

The “Inline style capability” represents information indicating whether the inline style (“inline style”) shown in FIG. 9A is possible. In this case, if a value of the “Inline style capability” is ‘0_{b}’, the inline style is impossible. On the other hand, if a value of the “Inline style capability” is ‘1_{b}’, the inline style is possible.

For instance, if a value of the “Inline style capability” is ‘0_{b}’, it is unable to reproduce an inline style in the player despite that a font set, font style, font size and font color of a text in part is defined like FIG. 9B. On the other hand, if a value of the “Inline style capability” is ‘1_{b}’, an inline style can be reproduced as exemplarily shown in FIG. 9B.

The “BIG5” represents BIG5 characters code and information indicating whether decoding is possible. In this case, BIG5 is a character code to indicate Chinese Characters (Traditional Chinese Characters). If a value of the “BIG5” is ‘0_{b}’, reproduction or decoding of the character code is impossible. On the other hand, if a value of the “BIG5” is ‘1_{b}’, reproduction or decoding of the character code is possible.

The “CN-GB” represents information indicating whether encoding of GB2312 is possible. In this case, the GB2312 is a character code to indicate Chinese Characters (Simplified Chinese Characters). If a value of the “CN-GB” is ‘0_{b}’, decoding of the character code is impossible. On the other hand, if a value of the “CN-GB” is ‘1_{b}’, decoding of the character code is possible.

The “GB18030-2000” represents GB18030-2000 characters code and information indicating whether decoding is possible. In this case, GB18030-2000 is a character code to indicate Chinese Characters including GBK character code. If a value of the “GB18030-2000” is ‘0_{b}’, reproduction or decoding of the character code is impossible. On the other hand, if a value of the “GB18030-2000” is ‘1_{b}’, reproduction or decoding of the character code is possible.

The “EUC-KR” represents information indicating whether decoding of KSC 5601-1987 is possible. In this case, the KSC 5601-1987 is a character code to indicate Korean Complete Characters. If a value of the “EUC-KR” is ‘0_{b}’, decoding of the character code is impossible. On the other hand, if a value of the “EUC-KR” is ‘1_{b}’, decoding of the character code is possible.

The “Shift_JIS” represents Shift_JIS characters code and information indicating whether decoding is possible. In this case, Shift_JIS is a character code to indicate Japanese Characters. If a value of the “Shift_JIS” is ‘0_{b}’, reproduction or decoding of the character code is impossible. On the other hand, if a value of the “Shift_JIS” is ‘1_{b}’, reproduction or decoding of the character code is possible.

In some cases, an optical record player 10 may reproduce all of the text subtitles corresponding to the text subtitle information except the specific information according to a value set in PSR30. For instance, if a value of in-line style flag is 0, the optical record player 10 interprets and reproduces the text subtitles ignoring the in-line style flag.

On the other hand, an optical record player 10 may reproduce text subtitles except a text subtitle associated with specific information according to a value set in PSR30. For instance, if a value of in-line style flag is 0, the optical record player 10 may reproduce text subtitles except a text subtitle associated with the in-line style flag.

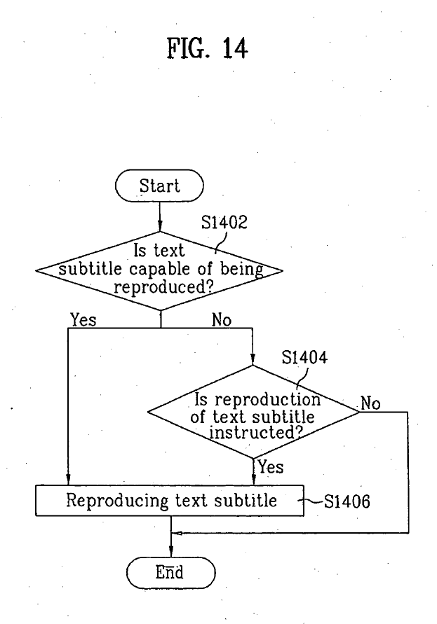

FIG. 14 is a flowchart of a data reproduction sequence according to an embodiment of the present invention, in which a text subtitle stream included in supplementary data is reproduced in sequence according to reproduction possibility information of a player. In this case, the reproduction possibility information is stored in one of the Player Status Registers (PSRs) included in a playback system of the player, e.g., PSR30.

Referring to FIG. 14, an optical record player 10 decides whether a reproduction support of a text subtitle is possible based on the PSR30 (S1402). For example, by checking whether the character code related to character code information of text subtitle stream indicates reproduction is capable or not in PSR30. The character code information of each text subtitle stream is included in an STN_table. In this case, a text subtitle stream is extracted from data recorded in an optical disc or data received from an external input source for example.

For instance, the optical record player 10 decides whether a reproduction of language code and style information of a text subtitle included in data is supported based on text subtitle information and text format information stored in a memory unit. In this case, the text subtitle information includes “User changeable style set capability”, “Text flow & alignment capability”, “Outline border capability” and “Inline style capability”. And, the text format information includes “BIG5”, “CN-GB”, “GB18030-2000” and “EUC-KR’, “Shift_JIS” fields.

If it is decided in step S1402 that reproduction support is not possible, the optical record player 10 decides whether a reproduction of the text subtitle is instructed (S1404). The optical record player 10 decides the instruction of the reproduction by checking a field value of “Unsupported Language Capability”.

Subsequently, if it is decided in the step S1404 that the reproduction is instructed, the optical record player 10 reproduces the text subtitle (S1406). Yet, in this case, the reproduction can be carried out in a text style or text format supported by the optical record player 10 regardless of an author's intention. In some cases, if the language code is not supported, a user may not understand a corresponding meaning due to the reproduction with broken codes.

For instance, if a value of the “Shift_JIS” is ‘0_{b}’ and if a value of the “Unsupported Language Capability” is ‘1_{b}’, a user is able to view a corresponding text since the optical record player 10 is capable of reproducing a text subtitle despite not supporting Japanese Character Code. Yet, the text may differ from a text recorded by an author.

On the other hand, if it is decided in the step S1402 that the reproduction support is possible, the optical record player 10 reproduces the text subtitle (S1406). In this case, the text subtitle can be reproduced in a text style or text format intended by an author. For instance, if a value of the “User changeable style set capability” is ‘1_{b}’, a user can change a style set.

Accordingly, the present invention can reproduce a text subtitle according to an environment of a player.

It will be apparent to those skilled in the art that various modifications and variations can be made in the present invention without departing from the spirit or scope of the inventions. Thus, it is intended that the present invention covers the modifications and variations of this invention provided they come within the scope of the invention.

What is claimed is:

1. A reproducing apparatus for reproducing data from a recording medium, comprising:
a decoder configured to decode a text subtitle reproduced from the recording medium; and
a memory configured to store text subtitle capability information indicating whether the apparatus has at least one text subtitle capability, the text subtitle capability information including at least one of style capability information indicating whether the apparatus has at least one text subtitle style capability, text flow information indicating text subtitle flow and alignment combinations supported by the apparatus, outline border capability information indicating whether a display of an outline border is supported by the apparatus, and inline style capability information indicating whether the apparatus supports handling inline style information.

2. The apparatus of claim 1, wherein the text subtitle capability information includes the style capability information indicating whether the apparatus has at least one text subtitle style capability.

3. The apparatus of claim 1, wherein the style capability information is user changeable style capability information indicating whether the apparatus supports allowing a user to change style information for displaying a text subtitle.

4. The apparatus of claim 1, wherein the text subtitle capability information includes the text flow information indicating text subtitle flow and alignment combinations supported by the apparatus.

5. The apparatus of claim 4, wherein the text flow information indicates one of i) all text subtitle flow and alignment combinations are capable, and ii) first and second text subtitle flow and alignment combinations are capable, the first text subtitle flow and alignment combination is left-to-right character text flow and top and left alignment within a text box, and the second text subtitle flow and alignment combination is right-to-left character text flow and top and right alignment within the text box.

6. The apparatus of claim 1, wherein the text subtitle capability information includes the outline border capability information indicating whether a display of an outline border is supported by the apparatus.

7. The apparatus of claim 1, wherein the text subtitle capability information includes the inline style capability information indicating whether the apparatus supports handling inline style information.

8. The apparatus of claim 1, wherein the text subtitle capability information includes user changeable style capability information, as the style capability information, indicating whether the apparatus supports allowing a user to change style information for displaying a text subtitle; the text flow information indicating text subtitle flow and alignment combinations supported by the apparatus; the outline border capability information indicating whether a display of an outline border is supported by the apparatus; and the inline style capability information indicating whether the apparatus supports handling inline style information.

9. The apparatus of claim 8, wherein the text subtitle capability information further includes font type information indicating whether the apparatus supports at least one font type for display of text subtitles.

10. The apparatus of claim 1, wherein the text subtitle capability information further includes font type information indicating whether the apparatus supports at least one font type for display of text subtitles.

11. The apparatus of claim 10, wherein the font type is BIG5.

12. The apparatus of claim 10, wherein the font type is CN-GB.

13. The apparatus of claim 10, wherein the font type is GB 18030-2000.

14. The apparatus of claim 10, wherein the font type is EUC-KR.

15. The apparatus of claim 10, wherein the font type is Shift JIS.

16. The apparatus of claim 10, wherein the text subtitle capability information includes font type information for the font types of BIG5, CN-GB, GP18030-2000, EUC-KR, and Shift JIS.

17. The apparatus of claim 10, wherein the text subtitle capability information further includes unsupported language capability information indicating whether a user is permitted to select a text subtitle in a font type not supported by the apparatus for reproduction from the recording medium.

18. The apparatus of claim 1, wherein the text subtitle capability information further includes unsupported capability information indicating whether a text subtitle not supported by the apparatus is selectable by a user operation for reproduction from the recording medium.

19. A reproducing apparatus for reproducing data from a recording medium, comprising:
a decoder configured to decode a text subtitle reproduced from the recording medium;
a memory configured to store text subtitle capability information indicating whether the apparatus has at least one text subtitle capability, the text subtitle capability information including at least one of style capability information indicating whether the apparatus has at least one text subtitle style capability, text flow information indicating text subtitle flow and alignment combinations supported by the apparatus, outline border capability information indicating whether a display of an outline border is supported by the apparatus, and inline style capability information indicating whether the apparatus supports handling inline style information; and
a control unit configured to control operation of the apparatus based on the text subtitle capability information such that a text subtitle is reproduced from the recording medium if the text subtitle capability information indicates the apparatus is capable of reproducing the text subtitle.

20. The apparatus of claim 19, wherein
the text subtitle capability information further includes font type information indicating whether the apparatus supports at least one font type for display of text subtitles; and
the control unit is configured to determine whether a font type of a text subtitle recorded on the recording medium is supported by the apparatus based on the font type information, and the control unit is configured to allow reproduction of the text subtitle from the recording medium if the control unit determines that the font type information indicates the font type of the text subtitle is supported by the apparatus.

21. The apparatus of claim 20, wherein
the text subtitle capability information further includes unsupported language capability information indicating whether a user is permitted to select a text subtitle in a font type not supported by the apparatus for reproduction from the recording medium; and
the control unit is configured to determine whether a user is permitted to select a text subtitle in a font type not supported by the apparatus for reproduction based on the unsupported language capability information if the font type information indicates the font type of the text subtitle recorded on the recording medium is not supported by the apparatus, and is configured to permit reproduction of the text subtitle if the control unit determines that the unsupported language capability information indicates a user is permitted to select a text subtitle in a font type not supported by the apparatus.

22. The apparatus of claim 19, wherein
the text subtitle capability information further includes unsupported capability information indicating whether a user is permitted to select a text subtitle for reproduction from the recording medium even if not supported by the apparatus; and
the control unit is configured to determine whether a user is permitted to select a text subtitle not supported by the apparatus for reproduction based on the unsupported capability information if the text subtitle capability information indicates the text subtitle on the recording medium is not supported by the apparatus, and the control unit is configured to permit reproduction of the text subtitle if the control unit determines that the unsupported capability information indicates a user is permitted to select a text subtitle not supported by the apparatus.

23. A method for managing reproduction of data from a recording medium, comprising:
storing text subtitle capability information in a reproducing apparatus, the text subtitle capability information indicating whether the apparatus has at least one text subtitle capability associated with reproducing text subtitles from the recording medium, the text subtitle capability information including at least one of style capability information indicating whether the apparatus has at least one text subtitle style capability, text flow information indicating text subtitle flow and alignment combinations supported by the apparatus, outline border capability information indicating whether a display of an outline border is supported by the apparatus, and inline style capability information indicating whether the apparatus supports handling inline style information.

24. The method of claim 23, wherein the text subtitle capability information includes the style capability information indicating whether the apparatus has at least one text subtitle style capability.

25. The method of claim 24, wherein the style subtitle capability information is user changeable style capability information indicating whether the apparatus supports allowing a user to change style information for displaying a text subtitle.

26. The method of claim 23, wherein the text subtitle capability information includes the text flow information indicating text subtitle flow and alignment combinations supported by the apparatus.

27. The method of claim 23, wherein the text subtitle capability information includes the outline border capability information indicating whether a display of an outline border is supported by the apparatus.

28. The method of claim 23, wherein the text subtitle capability information includes the inline style capability information indicating whether the apparatus supports handling inline style information.

29. The method of claim 23, wherein the text subtitle capability information further includes font type information indicating whether the apparatus supports at least one font type for display of text subtitles.

30. The method of claim 29, wherein the text subtitle capability information further includes font type information for the font types of BIG5, CN-GB, GP18030-2000, EUC-KR, and Shift JIS.

31. The method of claim 29, wherein the text subtitle capability information further includes unsupported language capability information indicating whether a user is permitted to select a text subtitle in a font type not supported by the apparatus for reproduction from the recording medium.

32. The method of claim 23, wherein the text subtitle capability information further includes unsupported capability information indicating whether a text subtitle not supported by the apparatus is selectable by a user operation for reproduction from the recording medium.

33. A method for managing reproduction of data from a recording medium, comprising:
storing text subtitle capability information in a reproducing apparatus, the text subtitle capability information indicating whether the apparatus has at least one text subtitle capability, the text subtitle capability information including at least one of style capability information indicating whether the apparatus has at least one text subtitle style capability, text flow information indicating text subtitle flow and alignment combinations supported by the apparatus, outline border capability information indicating whether a display of an outline border is supported by the apparatus, and inline style capability information indicating whether the apparatus supports handling inline style information; and
controlling operation of the apparatus based on the text subtitle capability information such that a text subtitle is reproduced from the recording medium if text subtitle capability information indicates the apparatus is capable of reproducing the text subtitle.

34. The method of claim 33, wherein
the text subtitle capability information further includes font type information indicating whether the apparatus supports at least one font type for display of text subtitles; and
the controlling step includes,
determining whether a font type of a text subtitle recorded on the recording medium is supported by the apparatus based on the font type information, and
allowing reproduction of the text subtitle from the recording medium if the font type information indicates the font type of the text subtitle is supported by the apparatus.

35. The method of claim 34, wherein
the text subtitle capability information further includes unsupported language capability information indicating whether a user is permitted to select a text subtitle in a font type not supported by the apparatus for reproduction from the recording medium; and
the controlling step includes,
determining whether a user is permitted to select a text subtitle in a font type not supported by the apparatus for reproduction from the recording medium based on the unsupported language capability information if the font type information indicates the font type of the text subtitle recorded on the recording medium is not supported by the apparatus, and
permitting reproduction of the text subtitle if the determining step determines that the unsupported language capability information indicates a user is permitted to select a text subtitle in a font type not supported by the apparatus.

36. The method of claim 33, wherein
the text subtitle capability information further includes unsupported capability information indicating whether a user is permitted to select a text subtitle for reproduction from the recording medium even if not supported by the apparatus; and
the controlling step includes,
determining whether a user is permitted to select a text subtitle not supported by the apparatus for reproduction from the recording medium based on the unsupported capability information if the text subtitle capability information indicates the text subtitle is not supported by the apparatus, and
permitting reproduction of the text subtitle if the determining step determines that the unsupported capability information indicates a user is permitted to select a text subtitle not supported by the apparatus for reproduction from the recording medium.

37. A storage medium for managing reproduction of data from a recording medium, comprising:
a status register in a reproducing apparatus, the status register storing text subtitle capability information indicating whether the apparatus has at least one text subtitle capability associated with reproducing text subtitles from the recording medium, the text subtitle capability information including at least one of style capability information indicating whether the apparatus has at least one text subtitle style capability, text flow information indicating text subtitle flow and alignment combinations supported by the apparatus, outline border capability information indicating whether a display of an outline border is supported by the apparatus, and inline style capability information indicating whether the apparatus supports handling inline style information.
